(19) United States
(12) Patent Application Publication
(10) Pub. No.: US 2010/0090576 A1
(43) Pub. Date: Apr. 15, 2010

(54) OMNIDIRECTIONAL LIGHT BULB USING LIGHT EMITTING DIODE

(76) Inventor: Der Ming JUANG, Sindian City (TW)

Correspondence Address: LEONG C LEI, PMB # 1008, 1867 YGNACIO VALLEY ROAD, WALNUT CREEK, CA, 94598, US

(21) Appl. No.: 12/250,547

(22) Filed: Oct. 14, 2008

(51) Int. Cl. H01J 61/92

(52) U.S. Cl. 313/1

(57) ABSTRACT

The light bulb contains a transparent body member and a contact member at an end of the body member that could be screwed into a conventional light bulb socket for establishing electrical connections. The light bulb also contains at least a disc and a supporting pole. A number of LEDs are back-to-back configured along the circumference of each disc with appropriate distance therebetween. The discs are threaded by the supporting pole with appropriate spacing therebetween. Each disc also contains a circuit for driving the LEDs that is connected to the contact member's electrical connections via an appropriate conduction mechanism in the supporting pole.

### BACKGROUND OF THE INVENTION

1. Field of the Invention

The present invention generally relates to light bulbs, and more particularly to a light bulb using light emitting diodes as light source and projecting light in substantially all directions.

2. Description of Related Art

Light emitting diodes (LEDs), due to their low power consumption, significantly less heat generation, and long life span, have been widely employed in various lighting applications. However, the light emanated by a LED is usually restricted in a limited range and, as such, most of the applications utilizing LEDs are projection-based, such as flashlights, vehicle lamps, streetlamps, etc. In contrast, the incandescent light bulbs commonly found in households produce omnidirectional light from heated filaments. Therefore, if the LEDs are to replace incandescent light bulbs in household applications, the problem of limited coverage has to be addressed.

### BRIEF SUMMARY OF THE INVENTION

Therefore, a novel light bulb using LEDs as light source capable of producing omnidirectional light is provided herein.

The light bulb contains a transparent body member and a contact member at an end of the body member that could be screwed into a conventional light bulb socket for establishing electrical connections. The light bulb also contains at least a disc and a supporting pole. A number of LEDs are back-to-back configured along the circumference of each disc with appropriate distance therebetween. The supporting pole is extended from the contact member into the body member and the discs are threaded by the supporting pole with appropriate spacing therebetween.

Each disc also contains a circuit for driving the LEDs that is connected to the contact member's electrical connections via an appropriate conduction mechanism in the supporting pole.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a side-view diagram showing an omnidirectional light bulb according an embodiment of the present invention.

FIG. 1b is a top-view diagram showing the omnidirectional light bulb of FIG. 1a.

FIG. 2 is a side-view diagram showing an omnidirectional light bulb according another embodiment of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

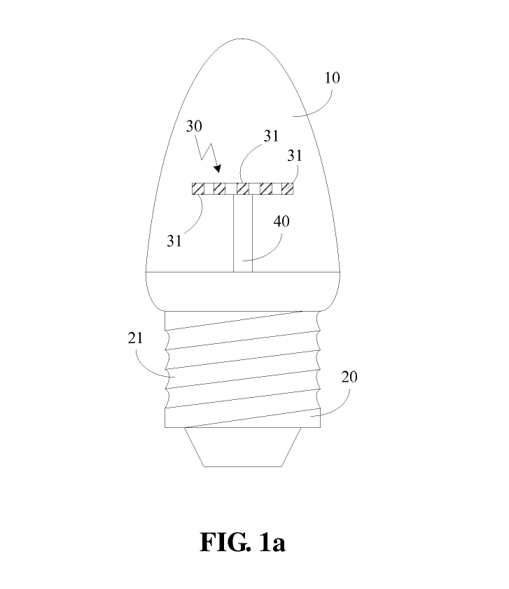

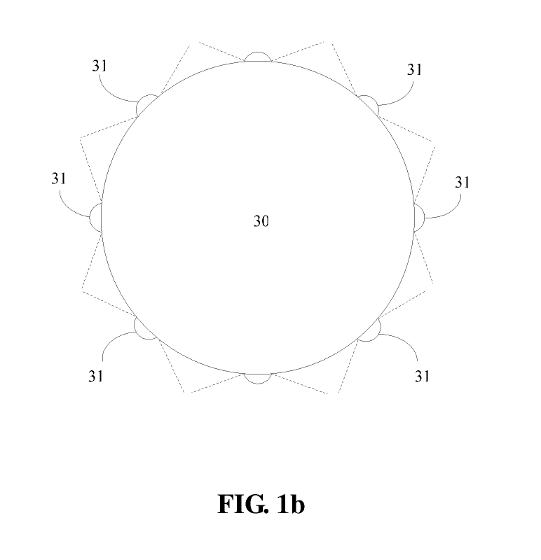

As shown in FIG. 1a, an omnidirectional light bulb according an embodiment of the present invention mainly contains a transparent and hollow body member 10. The body member 10 could have the usual spherical shape of ordinary light bulbs, or an egg-like shape as illustrated, or other appropriate shape.

To an end of the body member 10, there is a contact member 20 with threads 21 for screwing into an ordinary light bulb socket (not shown). The contact member 20, like all ordinary light bulbs, has two electrical contact points, one being the threads 21 and the other one at a bottom end of the contact member 20 (also not shown), so as to establish electrical connections with the light bulb socket. Inside the contact member 20, there could be circuits for electrical rectification and regulation and overload protection, etc. For people skilled in the related arts, these details are quite straightforward and therefore are omitted in the present specification and the accompanied drawings.

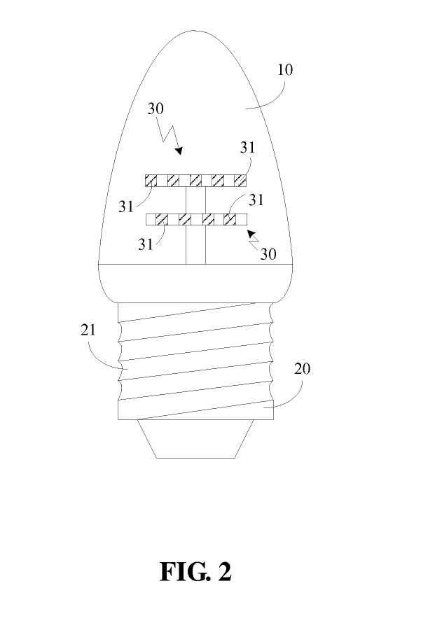

The omnidirectional light bulb further contains at least a disc 30 and a supporting pole 40. The disc 30 could have a circular shape as illustrated or a polygonal shape, etc. Along the circumference of the disc 30, there are a number of LEDs 31, with their backs towards the center of the disc 30 and with appropriate distance therebetween, projecting light towards the centrifugual directions, respectively. As further shown in FIG. 1b (with the dashed lines indicating the coverage of light), it should be clear the projected light from the LEDs 31 constitutes substantially an omnidirectional coverage, thereby solving the limited coverage problem. As such, as more LEDs 31 are employed on each disc 30, their distances are smaller, the coverage is more complete, and the light bulb is brighter. As shown in FIG. 2, for even more enhanced brightness, two or more discs 30 could be adopted.

As illustrated in FIG. 2, the supporting pole 40 is extended from the contact member 20 into the hollow body member 10, threading at least two discs 30 with appropriate vertical spacing therebetween. In this kind of multi-disc embodiments, to reduce the number of LEDs 31 without sacrificing the light bulb's brightness and coverage, the LEDs 31 on any two adjacent discs 30 are interleaved vertically. In other words, on any two adjacent discs 30, there is no LEDs 31 aligned vertically.

The supporting pole 40, in addition to the support of the discs 30, also provides electrical connectivity. On each disc 30, there is a circuit (not shown) for driving and provisioning electricity to its LEDs. The supporting pole 40 also contains a conduction mechanism for connecting the circuits on the discs 30 to the circuit inside and the electrical contact points of the contact member 20. Again, these details are quite straightforward to people of related arts and they are omitted here.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An omnidirectional light bulb using LEDs as light source, comprising:
a transparent body member;
a contact member at an end of said body member, said contract member having a plurality of threads and electrical contacts along an outer surface for screwing into a light bulb socket for establishing electrical connectivity;
a supporting pole extended from said contact member into said body member; and
a first disc inside said body member and threaded by said supporting pole, said first disc having a plurality of LEDs along a circumference of said first disc with appropriate distance therebetween, said LEDs projecting light towards centrifugal directions, respectively, said first disc having a circuit for driving and provisioning electricity to said LEDs;
wherein said supporting pole has a conduction mechanism connecting said circuit of said first disc to electrical contacts of said contact member.

2. The omnidirectional light bulb according to claim 1, further comprising a second disc inside said body member and threaded by said supporting pole at an appropriate spacing from said first disc, said second disc having a plurality of LEDs along a circumference of said second disc with appropriate distance therebetween, said LEDs projecting light towards centrifugal directions, respectively, said second disc having a circuit for driving and provisioning electricity to said LEDs and connected to said conduction mechanism of said supporting pole.

3. The omnidirectional light bulb according to claim 2, wherein said LEDs on said first and second discs are interleaved vertically.
